(19) United States
(12) Patent Application Publication
(10) Pub. No.: US 2005/0217939 A1
(43) Pub. Date: Oct. 6, 2005

(54) Lifting system

(75) Inventors: John Bo Nielsen, Aalborg (DK); Erik Kristiansen, Lystrup (DK); Flemming Eriksen, Stovring (DK)

Correspondence Address: FOLEY AND LARDNER;SUITE 500, 3000 K STREET NW, WASHINGTON, DC, 20007, US

(73) Assignee: LIFTUP ApS

(21) Appl. No.: 10/981,763

(22) Filed: Nov. 5, 2004

Related U.S. Application Data
(60) Provisional application No. 60/517,774, filed on Nov. 5, 2003.

(51) Int. Cl. B66B 9/08

(52) U.S. Cl. 187/200

(57) ABSTRACT

A lifting system for a stairway provides steps that remain horizontal at all times. Thus the system may be used for lifting a person who is in a wheelchair or who in other ways is physically disabled, together with functioning as an ordinary stairway; hence, it also can be usable for walking-enabled persons.

### FIELD OF THE INVENTION

The invention relates to a lifting system for a stairway of a type where the steps of the stairway remain horizontal at all times. The system may e.g. be used for lifting a person using a wheelchair or in other ways being physically disabled together with functioning as an ordinary stairway, also usable for walking-enabled persons.

### BACKGROUND ART

In modern buildings, a significant problem posing a challenge to an architect is the connection between different levels in the building. The connections have to facilitate transportation of people that are not able to use regular stairways or only with great difficulty, e.g. physically impaired people using wheelchairs or parents with children in perambulators. The number of possibilities of lifting people is many, but they all involve considerable drawbacks.

A first solution is the use of an elevator, which has the advantage of being capable of transporting all kinds of persons and their goods and chattels. Further, it does not take up as much space as some of the other solutions. The disadvantages of elevators include the fact that they have to be combined with stairs to ensure safety and that they are very expensive to establish in new buildings as well as in existing buildings. Furthermore, elevators represent non-secure ways of escape during a fire or other emergency necessitating leaving the building.

A second solution is to combine stairs with a lifting system where the system includes a platform and rails following the stairs. The platform is held in a horizontal position as it slides up and down on the rails just above the stairs. When the platform is not in use, it is raised to a vertical storage position. One of the disadvantages is the unattractive and bulky look that this kind of system adds to the overall appearance of the stairs and the building. Also, the functioning of such platform limits the number of persons being able to escape during a fire or other emergency necessitating leaving the building.

A third solution is illustrated in U.S. Pat. No. 5,234,078. This solution combines the functionality of stairways with the ones of elevators, which creates the possibility of stairway types that may be used as regular stairways as well as for lifting an impaired person in a wheelchair from one level to another. The lifting system involves lifting of a platform connected to the upper end of the stairway by raising the platform and the stairway itself to a higher level.

The movement is established by a motor means lifting the lower end of the stairway along two posts. This is a problem since the motor means, among other things, disturb the aesthetic appearance of the system and require a space below the stairs to facilitate the motor means.

SE 462 335B discloses an escalator comprising an elevator section with a stair section attached to it, where the elevator section incorporates an elevator platform which can be raised and lowered between at least two levels. The stair section is connected to the elevator section in such a way that the stair section automatically follows the movements of the elevator section so that the stair section, in its lowered position, forms a flat surface on which goods can be transferred onto the elevator platform, while in its raised position it forms a normal staircase. The dimensional extent, even in the lowered position is so that a special recess must be provided in the ground.

### SUMMARY OF THE INVENTION

An object of the invention may be to create a lifting system without the above-mentioned drawbacks of the background art.

Another object of the invention may also be to provide a lifting system that is steady and self-supporting and still requires the lowest possible number of simple, lightweight and easy-to-assemble elements.

Another object of the invention may be to provide a construction that due to its design and the solutions provided is a safe lifting system that provides a safe lifting function. A still further object of the invention may be to provide a lifting system that requires an absolute minimum of maintenance, if any.

When, as stated in claim 1, a lifting system for a stairway comprises a first section including lifting means, a second section including a number of steps, step controlling means and sliding means, and at least one flexible connection connecting the first and second sections whereby the second section further includes step controlling means comprises one or more banisters and connection means connecting the banisters to the steps, it is possible to combine the functionality of a stairway with that of a lifting system in an advantageous manner.

The lifting system is especially advantageous in connection with limited distances such as e.g. between two levels in a building only separated by a few meters. Usually, the lifting system is used as a single unit but a number of lifting systems may also be used together so as to form e.g. a staircase in a building with a number of floors. In the latter example, the lifting system may connect a floor with a landing and continue to the next floor with a new lifting system. Hereby, it is possible to e.g. establish a lifting system in existing buildings with no elevators in an inexpensive way.

When, as stated in claim 2, the lifting means comprises a number of substantially vertical guide rails, and preferably two, secure and stable lifting of the cargo is established.

When, as stated in claim 3, the substantially vertical guide rails are mounted on a wall or a similar vertical surface, a lifting system is easily established. Furthermore, it is possible to establish a lifting system where only the stairway parts are visible, which creates a more esthetic system compared with the know systems. In particular, the positioning of the rails on a wall will help conceal the rails or even hide them by mounting into the wall.

When, as stated in claim 4, the lifting means comprises drive means such as electric or hydraulic motors, a further advantageous embodiment of the invention has been obtained. Especially, the size of the drive means is important in relation to hiding or concealing this part of the lifting system which takes place by means of an electric or hydraulic motor construction.

At the same time, the mentioned types may be controlled in a precise and fast manner with standard control systems. Other systems well-known by skilled persons within the art may also be used.

When the step controlling means comprises one or more banisters and connection means connecting the banisters with the steps, it is possible to use the necessary safety measures of a stairway as part of the lifting system. The step controlling means has the further advantage of controlling the steps from the top side which allows the underside of the steps to be flat. Hereby, the lifting system may be constructed without any means under the steps which ensures an elegant, esthetic and slim look of the lifting system. The lifting system will also provide a wheelchair user with easy entrance to the lifting system because the step is the only elevating element.

When, as stated in claim 5, the connection means is connected to the steps in close proximity to the front and rear edges of the steps, respectively, the control means allows for an altogether light-weight construction.

When, as stated in claim 6, the sliding means comprises a number of substantially horizontal guide rails, and preferably two, it is possible to control the movement of the lifting system when moving it from one level to another. In particular, it is possible to avoid malfunction by keeping the rails clear of obstacles and detecting any obstacles by detectors placed along the rails. However, the lifting system may be constructed without the rails and allow the system to move freely in a simple form.

When, as stated in claim 7, the second section has guides for entering into the sliding means, it is possible to create a preferred slide by coating the guides with e.g. a material having a low friction coefficient or with a wear-resistant material.

When, as stated in claim 8, the first section further includes a door, a bar or another access controlling means, access to the lifting system is restricted to the periods during which the system is ready for use.

When, as stated in claim 9, the number of steps is between 1 and 15, a preferred relation between the elevation and the size of the system has been obtained.

The invention also concerns a method of lifting cargo/person(s) by means of a lifting system from one level to another, the method comprising the steps of lifting a first section by means of lifting means, lifting a second section including a number of steps, the lifting of the second section being performed through a flexible connection to the first section, whereby the position of the number of steps is controlled by step controlling means comprising one or more banisters and connection means connecting the banisters to the steps.

When the lifting system operates as described, the lifting system obtains the objects of the invention. In particular, a safe and simple system is provided by using the banisters for controlling the steps.

According to a specific embodiment of the method according to the invention the method further comprising the step of the at least one sliding guide of the second section sliding in a horizontal guide rail during the lifting. A sliding guide, such as a wheel provided in a proximate end of the side member, may be preferred. It is possible to have the sliding means sliding in a horizontal guide rail, but it may be preferred to avoid the need for such a guide in a flooring but the wheel simply running on the flooring.

According to an preferred embodiment of the method according to the invention, the lifting system comprises two first sections, one section provided in the vicinity of each of the two ends of the banisters and wherein each of the two first sections is a step of a first type of steps and the second section comprising a number of a second type of steps and the method comprising the steps of

activating one of the lifting means provided in connection with each of the two steps and hereby providing

a raising or a lowering of one of the two first types of steps and hereby raising or lowering the at least one second type of step.

The construction of a lifting system according to the invention provides this advantageous connection between the method step of activating the lifting means in one end and the method step of hereby raising or lowering the first type of step and hereby raising or lowering the second type of steps.

According to a further preferred embodiment of the method according to the invention, the method further comprises the steps of

activating at least one of the lifting means provided in connection with each of the two steps of the first type and hereby providing

raising or lowering of at least one of the two first type of step and hereby raising or lowering of the at least one second type of step and hereby

providing a substantially equal level of relative height above a predetermined flooring level of the two first type of steps, and hereby

obtaining a platform comprising the steps of the first type of steps (102) and the steps of the second type of steps.

By obtaining the platform comprising the steps of the first type of steps and the steps of the second type of steps and surrounded by the banisters, a very safe and compact lifting platform is obtained. The lift is more compact than a lift with a dedicated platform. The dedicated platform must normally have a floor area for e.g. a human in a wheelchair.

According to a still further preferred embodiment of the method according to the invention, the method further comprises the steps of

activating a substantially equal lowering or raising of the lifting means provided in connection with each of the two steps of the first type while

maintaining the platform and hereby providing a lifting platform comprised by the steps of the two types for raising or lowering of objects and/or persons.

Hereby, a substantially plane platform for raising or lowering persons and/or objects is obtained.

In preferred embodiments of the lifting system according to the invention

the first section comprises at least one first type of step, and

the second section comprises at least one second type of step, and

the step controlling means comprises at least one banister, and

the flexible connection comprises a third swivel joint, and

the connection means comprises at least one baluster.

According to preferred embodiments of the invention, a lifting system is envisaged for a stairway for providing a self-supporting lifting system, the lifting system comprising

at least one step of the first type and at least one step of the second type, the first type of steps and second type of steps being provided displaceable in relation to each other,

the at least one step of the first type being fixed to at least one lifting means for raising and lowering the at least one first type of step and the at least one second type of step,

the at least one step of the first type or the second type being fixed to a lower end of at least one substantially vertically extending baluster, and

an upper section of the at least one baluster being attached to the banister, the banister extending from a proximate end of the stairway to a distant end of the stairway

the at least one step of the first type or the second type together with the at least one baluster being able to pivot at first swivel joints of the two sidepieces of the stairway in the proximity of the lower end of the baluster, the at least two sidepieces extending from one end of the stairway to another end of the stairway, and

the at least one baluster being pivotally joined to the banister at second swivel joints in the proximity of the upper end of the at least one baluster and

each of the two sidepieces being pivotally hinged to the lifting means at third swivel joints in the proximity of other end of the two sidepieces, and

wherein activating the lifting means provides a raising or a lowering of the at least one first type of step and hereby a raising or lowering of the at least one second type of step.

By fixing the baluster, preferably rigidly, to the steps at a lower end of the baluster according to the invention a steady lifting system is provided as this increases the rigidity of the system. When fixing the steps rigidly to the baluster a momentum torque can be transferred by the connection. This means that the two elements consisting of at least one step of the first or second type and the baluster acts as one rigid element. This connection may or may not be provided by any intermediate connection means.

An alternative to fixing both the steps of the first and the second type rigidly to the lower end of the balusters is e.g. to attach the first type of step rigidly only to the lifting means and only attach the second type of steps rigidly to the balusters.

Fixing the at least one first type of step to the lifting means may be provided by rigidly attaching the lifting means to the step of the first type or by rigidly attaching a baluster fixed to the first type of step to the lifting means. The attachment may as an alternative be provided by a combination of attaching both the step of the first type and a baluster being rigidly fixed to the first type of step to the lifting means.

By also attaching the sidepieces to the lifting means according to the invention, the steadiness of the invention is further improved and the independence of the lifting system is greatly increased in relation to the possible building the lifting system is to be functioning together with and in relation to any different functioning of the lifting system.

The lifting means may be electrical actuators, air-pressurized or hydraulically pressurized cylinders or the like means adapted to provide a displacement suitable for lifting of e.g. a wheelchair with a walking-impaired person.

The steps or any part supporting the steps may be formed in a way so as to at least partially support other steps, when the lifting means is in their lowest position. The support may be provided by the steps at least partly overlapping each other or being interconnected in any suitable manner. The upper surfaces of the steps should though still be at the same level non-dependent on any mutual overlapping or interconnection. This may e.g. be provided by a step overlapping another step and vice versa and dove-tail groves being provided in neighboring edges of the steps in order for the overlapping part not to prevent the surfaces of the steps from being at the same level when the stairway is in a lowermost position. Thus, any overlapping or interconnection must preferably not impair a surface of the steps being flush or in level with each other, when the steps are in a lowermost position.

According to a preferred embodiment of the invention, one of the first type of steps is attached to a platform or is forming a platform, the platform being intended for being raised or lowered by the lifting means by the attachment of the first type of step to the lifting means, and the lifting means being adapted for providing a force on the first type of step, which is substantially in the direction of gravity, and the sidepieces in a proximate end being provided with means for allowing a lateral displacement of the sidepieces.

The means allowing lateral displacement of the sidepieces is provided in order to make it easy for the sidepieces to slide on the flooring and as part of the means to prevent forces other than in the direction of gravity to act on the lifting means. The first step or the platform may be adapted so as to provide a number of lifting means for support and substantially only having forces in the direction of gravity acting on the first step of platform or so as to at least minimize the magnitude of forces not acting in the direction of gravity. By providing the lifting system in this way e.g. the maintenance of the system is limited along with fulfilling other objects of the invention.

Preferably, a first step of the second type of step is provided with a ramp for enabling a walking-impaired person and/or an aid for a walking-impaired person to enter or exit the first step, when the first step is in a lowermost position. Even more preferred, the ramp is flush with the flooring when the first step of the second type is not in its lowermost position, and the ramp is activated only when the first step of the second type is in its lowermost position. Activation of the ramp takes place automatically, when the first step of the second type is lowered towards the lowermost position. The ramp may be provided as described under the detailed description, but may also be provided to act as a stop, when the step at the ramp is not in its lowermost position and act as a ramp, when the step is in its lowermost position, i.e. the ramp is pivoted upwards when the step is not in a lowermost position. The safety is enhanced against accidental rolling off of a wheelchair.

According to a possible embodiment, the steps are rigidly attached to the lower end of the balusters by a first attachment means such as an L-shaped bracket, the first attachment means also being provided with means for attaching the first attachment means to the first swivel joints of the sidepieces. Thereby, the first attachment means interconnects the steps with the sidepieces by means of the first swivel joints, and the number of individual elements are reduced for ensuring the functioning of the lifting system. Thus, in a possible embodiment, the possible L-shaped bracket may be provided with the swivel joint itself, thus incorporating the attachment of the steps with the attachment of the balusters and even also with the attachment of the sidepieces.

The first attachment means may be provided as a frame extending along the outer edges of the step and hereby also extending from one sidepiece to the other opposite sidepiece and still also be used to attach the balusters at each side of the step. Thereby, the first supporting means may support at least a part of the surface of a step. Hereby, the first supporting means may be provided so as to make the rigidity and strength of the step and the lifting system as such independent of the choice of material for the surface of the step and hereby let the user or the architect choose the material. The first attachment means may be two separate parts, one part provided in each side of the step. The first attachment means may only consist in a bar that is attached to the side of the step for insertion in the sidepiece, and the baluster may be attached to the steps directly by fastening means such as screws, glue, key and groove or a combination thereof.

According to a possible additional or alternative embodiment, the upper end of the baluster is being pivotally attached to the banister by rigidly attaching the upper end of the baluster to a second attachment means, the second attachment means also being provided with means for forming the second swivel joint with the banister, the second attachment means thus interconnecting the baluster with the banister by means of the second swivel joints. Thereby, the second attachment means such as a longitudinal bar interconnects the balusters with the banisters by means of the second swivel joints, and the number of individual elements are reduced for ensuring the functioning of the lifting system. Thus, in a possible embodiment, the possible longitudinal bar may be provided with the swivel joint itself, thus incorporating the attachment of the banisters to the lifting system as such with the attachment of the balusters to the banisters.

The second attachment means is especially for use, when the material, such as tree, of the baluster is not strong enough. The second attachment means may as an alternative or additionally also be used to form part of a swivel joint being hidden in a groove at the underside of the banister. As an alternative, the second attachment means is rigidly attached to the banister and the upper end of the baluster is provided with means for connecting the second attachment means to the banister. Thus, many possibilities are listed of enhancing the security and limiting the number of elements of the lifting system.

By providing lifting means in both ends of the sidepieces, there is no need for a platform at the one end of the stairs. Additionally or alternatively, by the feature of the steps being provided in a rigid connection to the balusters, the construction according to the invention, such stairway and combined lifting system form a space saving and steady construction.

According to yet further embodiments of the invention, at least one of the first type of steps or second type of steps comprises a first detection means at an underside of the step for detection of any objects obstructing the steps from being lowered.

According to yet another embodiment of the invention, at least one of the first type of steps comprises a second detection means for detection of any objects present on the at least one first type of steps. The first and second detection means may also be combined with load detection means comprised with a control means for the lifting means.

According to embodiments of the invention the lifting system further comprises a control means being provided for receiving an input by a user and being connected to the lifting means and to the first detection means, the control means being capable of activating the lifting means according to user input and at the same time controlling the lifting means to be lowered only when clear signals are received from the first detection means.

Hereby further safety is incorporated into the system, in the embodiments of the invention where a platform is always present.

According to further embodiments of the invention, the lifting system further comprises a control means being provided for receiving an input by a user and being connected to the lifting means and to the first and second detection means, the control means being capable of activating the lifting means according to user input and at the same time controlling the lifting means to be lowered only when clear signals are received from the first and second detection means.

Hereby further safety is incorporated into the system, in the embodiments of the invention where a platform is formed by the steps, when the lifting means in both ends of the sidepieces is at the same level. When a person or object is present on the platform formed by the steps, the platform may not be transferred into an ordinary stairway. If this could happen, the objects may fall from the platform and be damaged or the persons may fall from the platform and be injured.

All the embodiments of lifting systems described may be used in a way so as to activate the lifting means, thereby provide a height difference between the steps being appropriate for physiotherapeutic training of a walking person. The invention is intended for being powered electrically by mains power supply. However, in case of an emergency situation or in case of a power drop-out of the mains electrical supply, an electrical power back-up may be envisaged, such as a battery for powering the lifting means. Also, for ensuring the safety also in emergency situations, emergency lighting may be provided for lighting up or at least for indicating the location of the lifting system.

### BRIEF DESCRIPTION OF THE FIGURES

The invention will hereafter be described with reference to the figures, where

FIG. 1a shows a perspective view of the lifting system with a stairway designed for lifting according to the invention,

FIG. 1b shows details of the lifting system,

FIGS. 2 to 7 show a preferred embodiment of the invention in which a wheelchair user is lifted from one level to another,

FIGS. 8a and 8b show sections of a vertical guiding rail,

FIGS. 9a and 9b show different examples of detector means, and

FIG. 10 shows an activation header according to the invention.

FIG. 11 and FIG. 11A-11D are perspective views of an embodiment of the invention with a separate stairway and lifting platform,

FIG. 12A-FIG. 12D are perspective views of an embodiment of the invention constituting a combined stairway and lifting platform in different situations,

FIG. 13A-13D show the lifting system as shown in FIG. 1, when the stairs are forming a flat surface,

FIG. 14A-14B show a side-view of a ramp and other parts, when a step is in a position different from a lowermost position, and

FIG. 15A-15B show a side-view of the ramp and other parts, when the step shown is in a lowermost position.

### DETAILED DESCRIPTION OF THE INVENTION

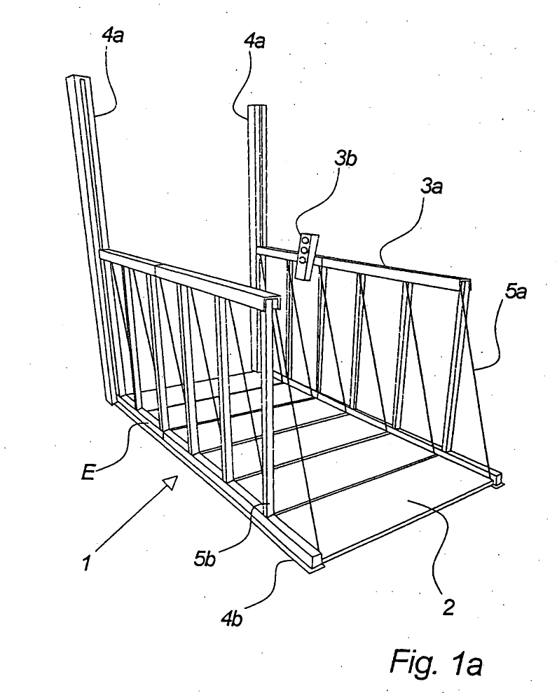

FIG. 1a shows a lifting system 1 according to the invention in which a stairway includes the functionality of elevating cargo or person(s) from one level to another. The persons may be persons perpetually or momentarily impaired such as elderly persons with walking disabilities, persons in wheelchairs or persons with broken extremities. The persons may also be parents with children in perambulators or persons with heavy or extensive goods and chattels.

The lifting system 1 comprises a number of steps 2 between two parallel side members E where the number of steps determines the elevation of cargo/person(s) and the height of the stairway.

In a preferred embodiment of the invention, the number of steps is maximal 15 allowing elevation of 1.5 to 2 meters.

Furthermore, the lifting system 1 comprises two banisters 3a, two vertical guide rails 4a and two horizontal guide rails 4b which control the lifting system 1 when lifting cargo in vertical and horizontal directions. The system also comprises a number of vertical banister rods 5b each connecting the banister 3a with the rear edge of a step 2. To keep the steps 2 in horizontal position a further banister rod or wire 5a connects the front edge of each step with the banister. Usually, the lifting system 1 comprises two banisters 3a connected to each side of the steps 2 with two identical sets of banister rods or wires 5a, 5b. During lifting of cargo/person(s), the steps 2 will remain essentially horizontal.

Even further, the lifting system 1 comprises a lifting control 3b with a number of buttons controlling the direction of elevation. The person wishing to be elevated has to push the right button to activate the lifting system.

In a preferred embodiment, the buttons are dead man's handles ensuring that elevation will be stopped in case the person stops pushing the button e.g. because of an indisposition. The button may, however, also be a standard button requiring only a single non-continuous push.

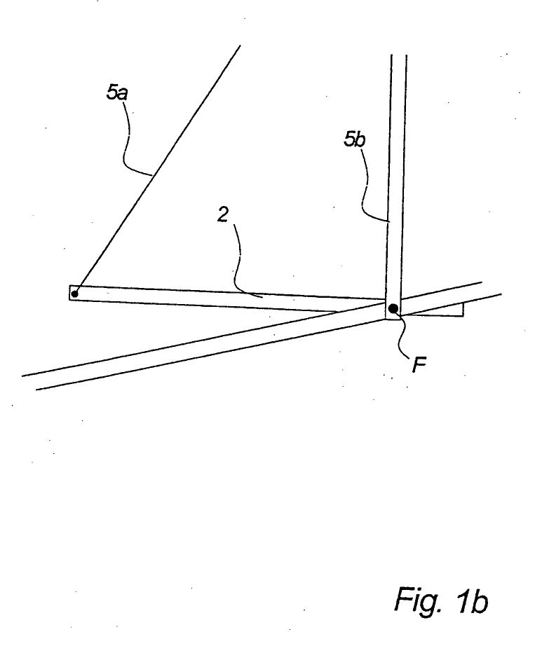

The lifting system 1 also includes drive means 10 (shown on FIGS. 2 to 7) to facilitate the upwards and downwards lifting and end stops informing the control system of the lifting system when it has reach its end position.

FIG. 1b shows a section of the lifting system in detail. Especially, the figure shows the flexible connection F between the step 2 and the side member E allowing the step to be horizontal during elevation.

FIGS. 2 to 7 show a preferred embodiment of the invention.

The preferred embodiment involves the following steps during elevation:

Downwards Lifting

1. The person requests the lifting service

2. The person activates an automatic door opening mechanism

3. The door opens

4. The person enters the platform (the first section) of the lifting system

5. Any safety leafs is in place

6. The person pushes the “down” button on the lifting control

7. The lifting system stops automatically when reaching the “down” position

8. When leaving the lifting system, the person moves through a photocell area and the system may return to normal position.

Upwards Lifting

1. The person requests the lifting service

2. The person moves through a photocell area and other persons cannot activate the system.

3. The person enters the platform (the first section) of the lifting system by moving over the steps.

4. The “up” button is pressed

5. Any safety leafs is in place

6. The lifting system stops automatically when the “up” position is reached and the door opens.

FIG. 2 shows the lifting system 1 when used as a stairway in the normal sense. The figure shows a wheelchair user 6 activating the lifting system 1 by pushing a button at an activation header 7 indicating that a wheelchair user 6 wishes to be transported to a lower level. The door 8 is open since the lifting system 1 is used as a stairway in the normal sense. However, the door acts as a part of the safety system in relation to the lifting system 1 and a lifting maneuver may consequently only take place when the door is locked.

A system including a bar that may be up or down for passage may replace the door.

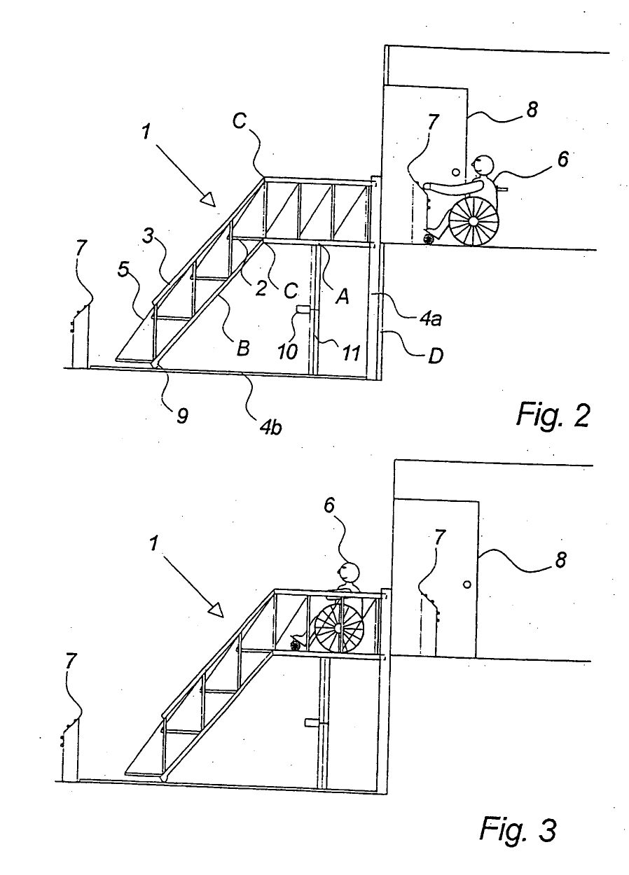

FIG. 3 shows the situation after the wheelchair user 6 has pushed the button on the activation header 7. The lifting system is divided into a first A and second section B where the first section A forms a platform onto which the wheelchair user 6 may push his wheelchair when the door is opened either manually or automatically. The second section B of the lifting system 1 comprises the part forming the steps when the lifting system acts as a stairway in the normal sense. When the wheelchair user 6 has positioned him or herself right onto the lifting system 1, the wheelchair user 6 needs to continuously push a safety device (a dead man's control) while he or she is transported down. The safety device may be a control panel on the platform of the stairway or a separate unit such as a remote control. When the safety device is pushed, the door is automatically locked which prevents other people from falling down from the upper floor.

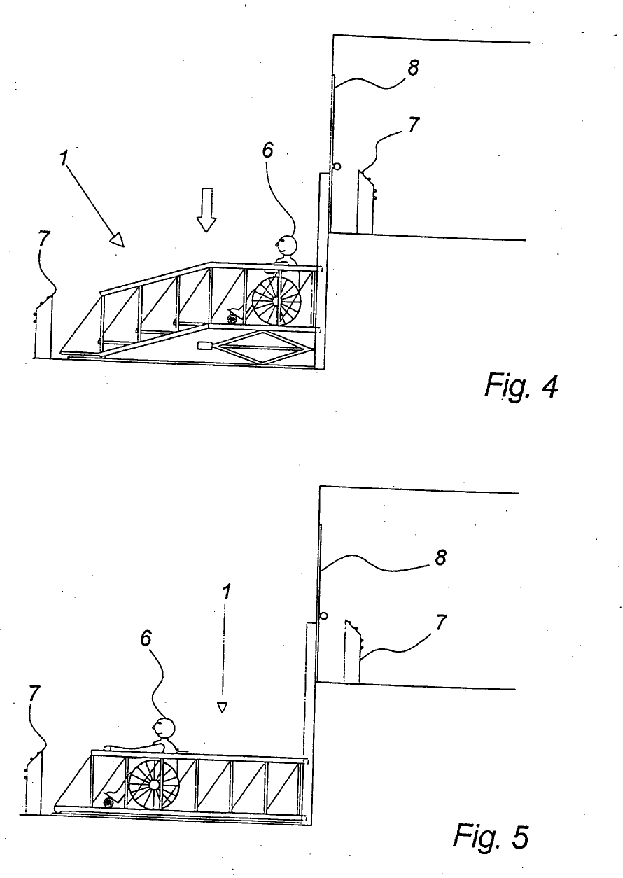

FIG. 4 shows the wheelchair user 6 on his way down where the user is pushing the safety button all the way down. In case the button is no longer pushed or a malfunction in the system is detected, the lifting system 1 will stop at once. A malfunction may e.g. be another person entering the safety area around the lifting system when in use.

At one end, the second section B ends in a flexible connection with the first section A. The first section A is lifted up or down by lifting means 10, 11 and the second section B is lifted by means of the flexible connection by the lifting means 10, 11.

The second section B of the lifting system further ends in a sliding guide 9 such as a wheel that slides within the horizontal guide rail 4b during movement of the lifting system 1.

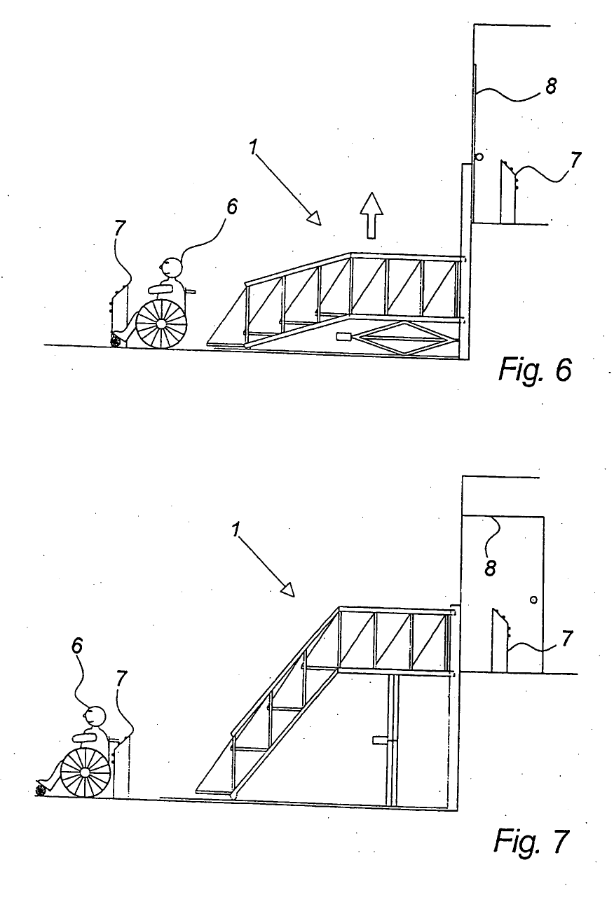

FIG. 5 shows a situation where the wheelchair user 6 has reached the lower level by means of the lifting system 1. When the lifting system 1 is down, the wheelchair user 6 may stop pushing the safety device and push himself away from the lifting system 1. The door 8 will still be locked until the lifting system 1 is back in the position of a regular stairway.

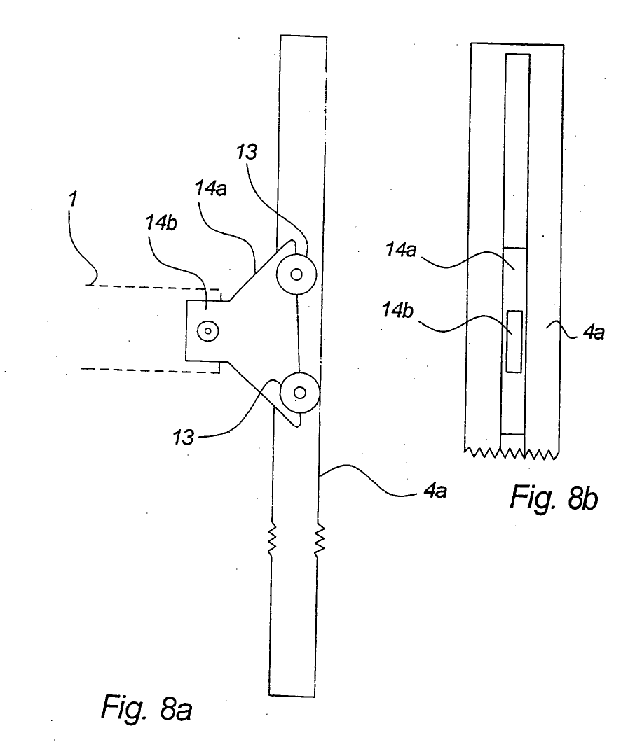

FIG. 6 shows the wheelchair user 6 after leaving the lifting system 1 and the system returning to the position of a stairway in the normal sense. During movement, the door is locked and prevents any dangerous situations from emerging so that no person can fall out of an open door before the stairway reaches normal use position. The lifting system 1 may automatically return to the position of a regular stairway when no persons are detected on the steps 2 or a person using the system manually requests the functionality he or she needs.

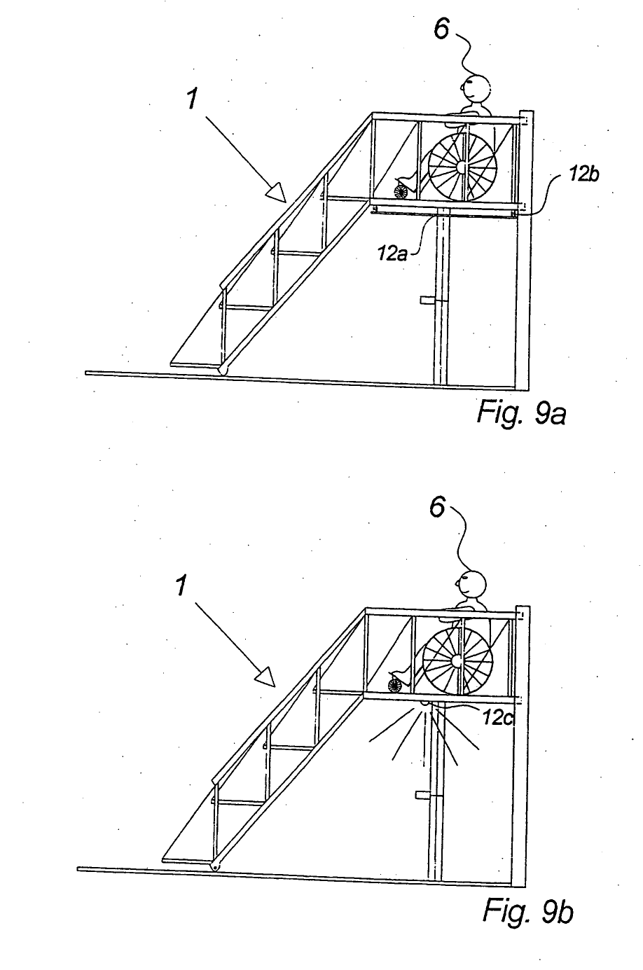

FIG. 7 shows the embodiment of FIG. 2 with the wheelchair user 6 at the bottom of the lifting system 1 and in the direction away from the lifting system 1. Now, the door is open at the top because the functionality of the lifting system is now a stairway in the normal sense. The stairway remains in position until someone pushes the activation header 7 once again in order to be lifted up or down by means of the lifting system 1.

It should be noted that this procedure may also take place in reverse order in accordance with the invention meaning that it would also be possible for a wheelchair user 6 to push the activation header 7 from the bottom of the lifting system 1. When the lifting system 1 is down, the wheelchair user 6 may drive onto the first section A constituting a platform and push the safety device to initiate elevation to another level.

FIGS. 2 to 7 also show lifting means 11 including the driving means 10. The lifting means is shown as a jaw tong mechanism and a screw-spindle connected to an electric motor e.g. through a gearing. However, a large number of different lifting and driving means is possible such as systems involving electric motors, hydraulic pumps/cylinders, racks, wires or actuators such as telescopic actuators. The means may be integrated in the vertical or horizontal rails 4a, 4b or be a part of a freestanding column/tower construction.

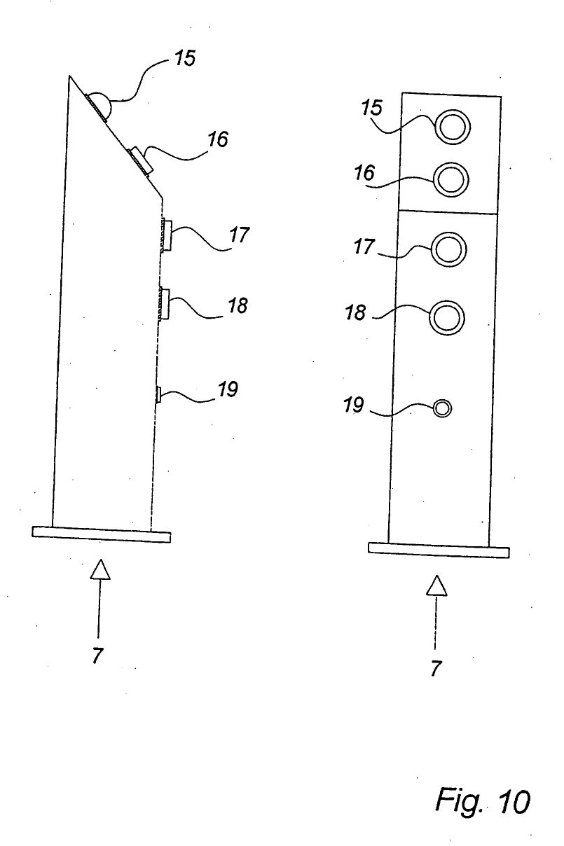

FIGS. 8a and 8b show sections of a vertical guide rail 4a. The guide rail 4a comprises one sliding wagon 14a with one or more wheels 13 rolling on the inner surface of the rail. The wagon has connections 14b to the lifting system 1 and the connections may be hinges or similar mechanical connections.

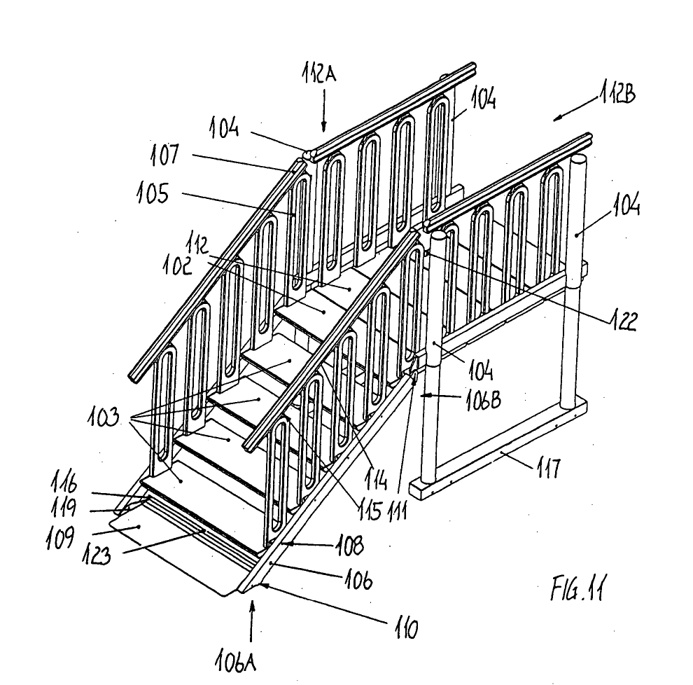

FIGS. 9a and 9b show different kinds of detection means detecting people or any type of cargo underneath the lifting system during lifting. The detection means reports to a control system controlling the functionality of the lifting system.

FIG. 9a shows a squared frame e.g. made of a metal tube. The frame is substantially identical in size with the first section A and is connected to the first section by means of springs and switching means 12b. The switching means detects any compression of the springs during movement of the lifting system 1 indicating that something is underneath the frame 12a e.g. a foot of a person and the control system automatically stops the lifting system 1.

FIG. 9a shows an electric detector system comprising a detector 12c transmitting light and determining whether something is underneath the lifting system or not by the reflection of the light. The detector system may be calibrated to detect any visible area underneath the lifting system.

An alternative would be a CCD camera securing the area below the stairway 1 from obstacles. If the CCD camera should detect something, the control system would automatically stop the lifting system 1.

Another way of holding the area beneath the lifting system 1 free from people or any type of cargo may be by attaching a shield of e.g. a fabric to each side of the lifting system 1. This prevents anyone from crawling under or placing cargo underneath the lifting system 1.

The lifting system 1 may also be provided with different light or sound signaling means warning people when the system is in use.

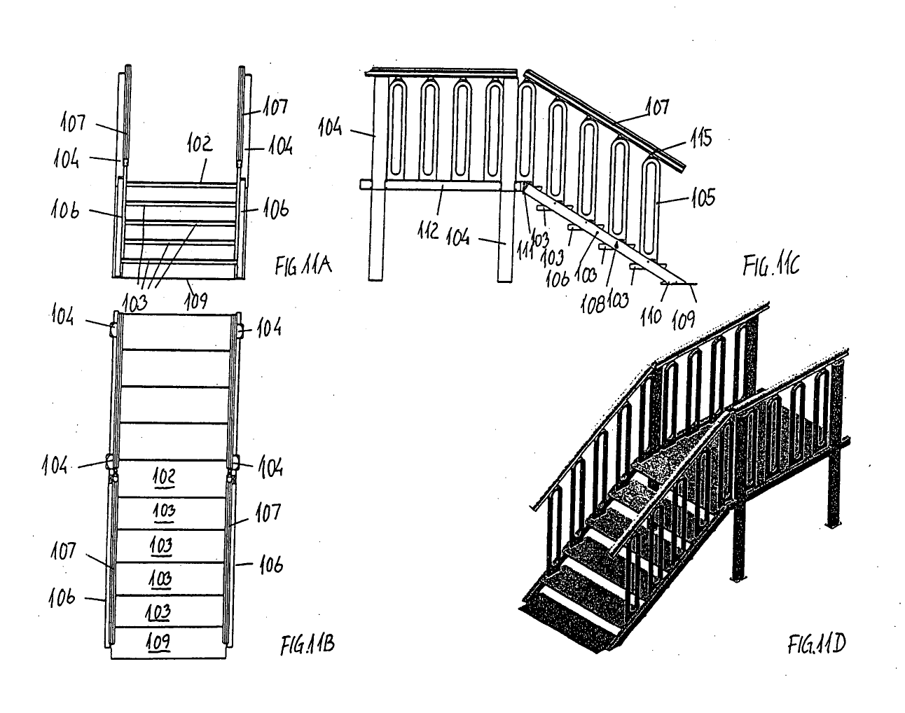

FIG. 10 shows a preferred embodiment of the activation header 7 comprising a lamp 15 indicating whether the lifting system 1 is active or not. Moreover, the activation header 7 may comprise a button 16 for opening the door 8. It includes two buttons for choice of transportation direction, one button 17 for lifting up and one button 18 to for lifting down. Furthermore the activation header 7 comprises a photoelectric cell 19 which detects if a person crosses the photocell area. With the detection, it is possible to let the control system of the lifting system 1 know whether the lifting system is empty or not.

An activation header 7 is positioned at each level of the lifting system 1 allowing persons at any level to activate the system. The activation header 7 positioned at the low level, having no door or bar, does not have the button 16 for opening of the door 8.

Together with other security measures, the photocells 19 and the detector means are all serially connected with the driving means 10 allowing any one of them to stop the lifting system in case of malfunction of any kind.

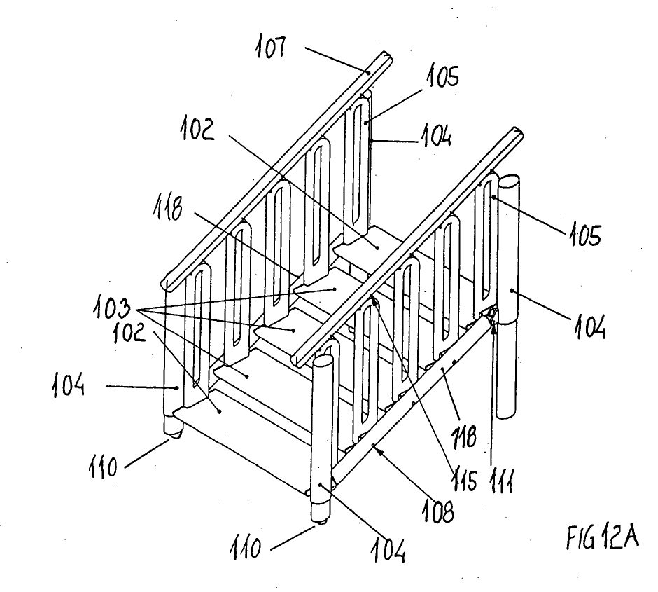

FIG. 11 and FIG. 11A-11D show a lifting system 101 according to a preferred embodiment of the invention. FIG. 11 shows a first type of step 102 being in a fixed relation in relation to lifting means 104 and being attached to at least one of the lifting means 104. In this embodiment of the invention, the lifting means consists of four electrically energized linear actuators connected to each corner of a platform 112. A baluster bracket 122 is provided for attaching the lifting means to a substantially vertically extending baluster 15. The fixed step 12 is also connected to a sidepiece 106 at a hinge 111. A second type of step 103 is provided and. The vertical level position of this second type of step is displaceable in relation to the fixed step 102 and hereby vertically displaceable in relation to the lifting means 104. In the embodiment of the invention shown, four steps 103 of the second type are provided. As seen from FIG. 11, both type of steps 102,103 are horizontal. Both types of steps will remain horizontal during raising and lowering of the lifting system.

At each side, all steps are rigidly attached to the substantially vertically extending baluster 5. Thus, the balusters 105 are shown here as being provided perpendicular to the steps. Each step of the second type of step 103 is supported by sidepieces 106 and each second type of step 103 is capable of pivoting at a swivel joint 108 in the proximity of the lower end of the balusters 105. Each baluster 105 is attached to a banister 107 by a swivel joint 115 and each baluster 105 is thereby able to pivot in relation to the banister 107. Each baluster 105 is also capable of pivoting in relation to the sidepieces 106 at the swivel joints 108.

Each of the two sidepieces 106 are in a distant end 106B hinged to the lifting means at a third swivel joint 111. In a proximate end 106A of the sidepieces 106, a wheel 110 or other like means is provided in order for the sidepieces 106 to displace laterally across a flooring (not shown) as the lifting system lowers or raises together with the platform 112 and the steps 102,103 of the first and second type.

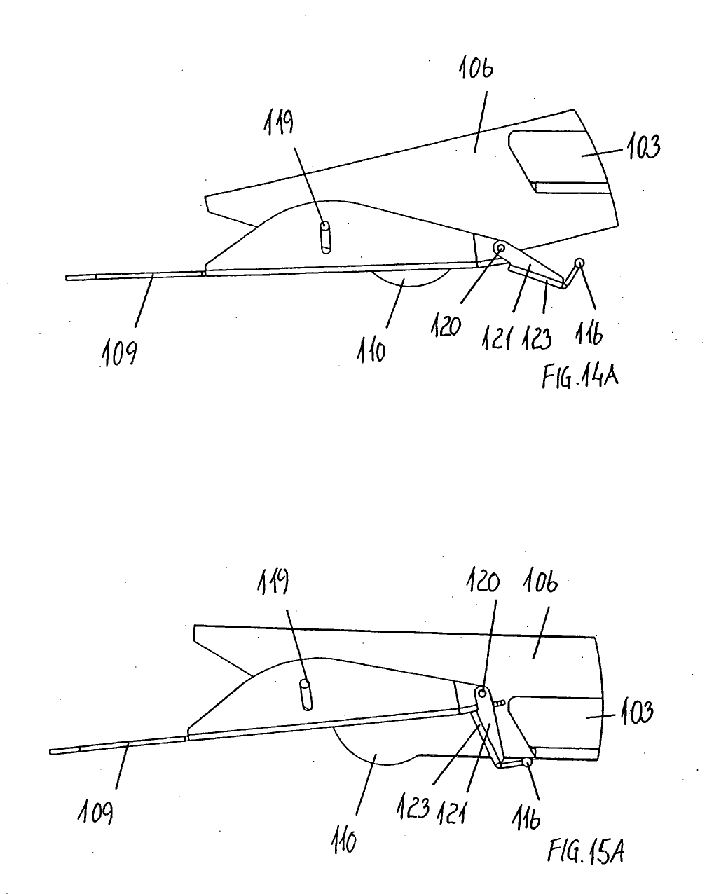

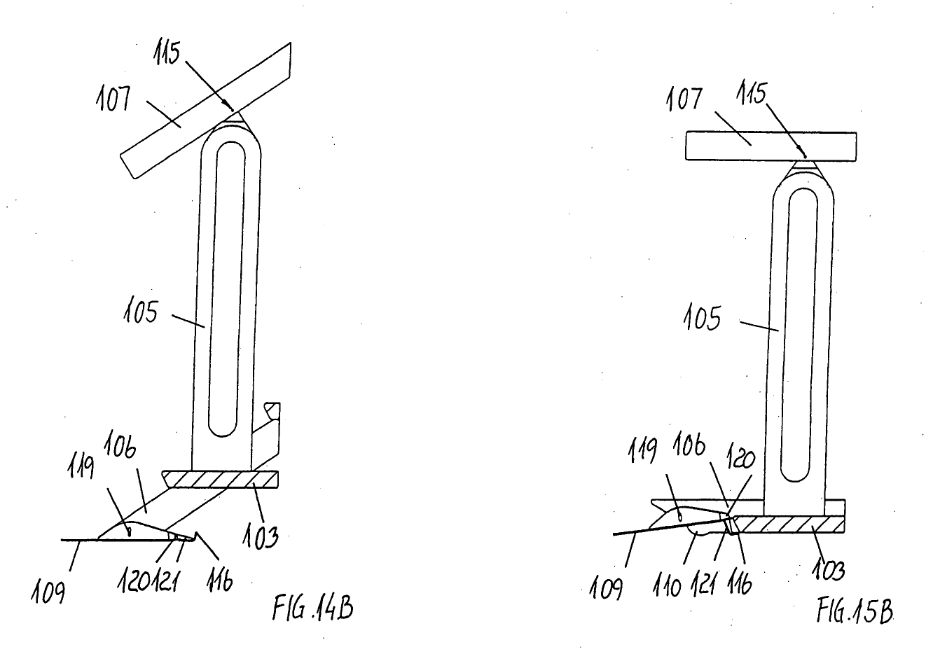

When the sidepieces 106 lower and the proximate end 106A of the sidepieces 106 displaces laterally across the flooring (not shown), the sidepieces will force a bar 116 downwards and hereby a ramp 109 will be lifted to form a surface extending from the surface of the flooring to an upper level of the second type of step 103 at the proximate end of the stairway. This feature of the invention is further described in FIG. 14 and FIG. 15.

The baluster 105 is connected to the steps 102,103 of the first and second type by a first attachment means 113 and a second attachment means 114 is provided for attaching the baluster 105 to the banister 107. The linear actuators forming part of the lifting means 104 is two and two mutually interconnected by beams 117, where only one beam 117 is shown in the figure, the other one in the perspective view being hidden by the platform 112. The beams 117 serve as part of other elements of the lifting system, thereby making the lifting system ‘self-supporting’, steady and rigid and hereby not necessary to require to be connected to any parts of the building, where the lifting system is installed. The beams 117 may however be omitted, and the linear actuators secured to the flooring (not shown) in one way or another.

Each step 102,103 may be installed with a first detection means (not shown) along an underside of the step for detection of any objects obstructing the steps from being lowered. One or more user terminals (not shown) may be placed at one or more places such as at the proximate end 106A of the stairway, on a proximate end 112A of the platform 112 at the distant end 106B of the stairway or at a distant end 112B of the platform 112. The detection means and the one or more user terminals may be connected to the lifting means and any energy source necessary for activating the lifting means through a control box (not shown) for controlling the lifting system. The control box will control the lowering and raising of the platform 112 and the steps 102,103 of stairway according to the user input and the detected signals by the detection means.

When activating the lifting means 104, all steps 102,103 of the first and second type will, due to the connections between the steps, the banisters 107, the balusters 105 and the lifting means 104, remain horizontal, but the vertical level of height of the upper surfaces of the steps 102,103 above the flooring level will change. As an example, the stairway may form a normal stairway and the platform 112 together with step 12 of the first type may be in a HIGH, raised level of height above the flooring as shown in FIG. 11. A user is sitting in a wheelchair on a LOW, flooring level of height. The user inputs on the user input means a signal signaling that the user wishes to be lifted from the LOW level to the HIGH level. If no objects are detected by the detection means at the underside of the steps 102,103 of the first type and the second type, the platform will be lowered until the steps form a flat surface and the ramp 109 connects the top surface of the steps with the LOW level surface of the flooring. The wheelchair user may enter the steps now forming a crossing from the flooring (not shown) to the platform 112, and the wheelchair user may move on until the user is positioned on the platform 112. When the user is positioned on the platform 112, the user may activate the lifting means and be lifted to the HIGH level.

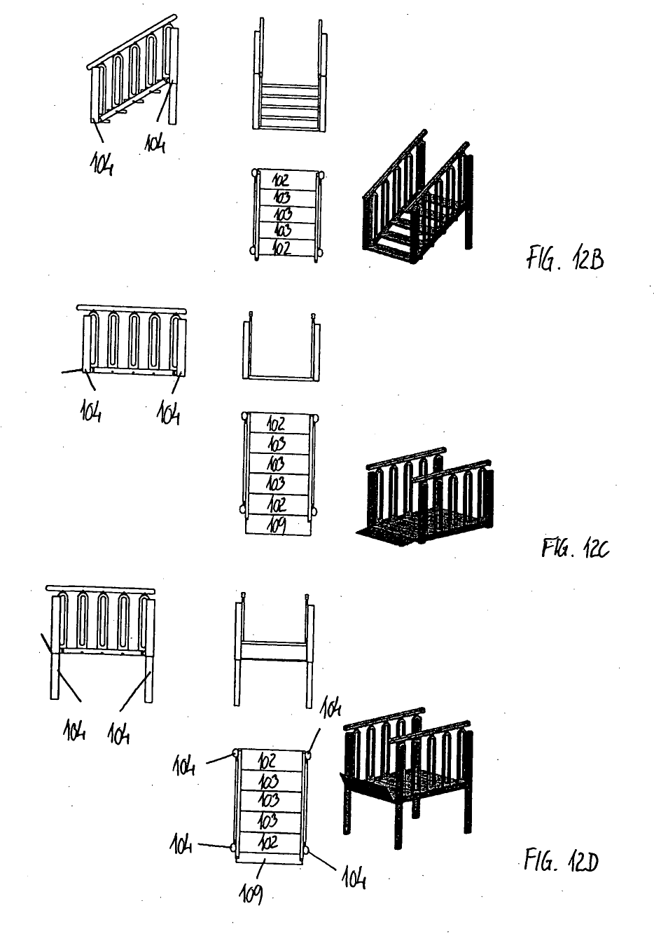

FIG. 12A shows another embodiment according to the invention. In this embodiment of the invention two steps 102 of the first type is shown, and three steps 103 of the second type is provided. In this embodiment of the invention, the lifting means consists of four electrically energized linear actuators placed in each corner of the stairway. The steps 103 are vertically displaceable in relation to the fixed steps 102 and hereby vertically displaceable in relation to the lifting means 104. The lifting means may in one or both ends of the stairway be connected to the baluster by baluster brackets 122 as shown in FIG. 11. In this embodiment of the invention, the sidepieces 118 are hinged to the lifting means 14 in both ends of the sidepieces 118 by means of a third swivel joint 111. The banisters 107 are connected to the balusters 105 and the balusters 105 are connected to the steps 103 as described in the description of FIG. 11.

According to the embodiment of the invention as shown in FIG. 12A-D, the lifting means may be activated so as to form a platform by all the five steps 102,103 of the stairway shown. This situation is shown in FIG. 12C. The user (not shown) may then move onto the platform formed by the steps and activate the lifting means in both ends and hereby be lifted to another level. This level is shown in FIG. 12B. As an example, the stairway may form a normal stairway and the step 102 of the first type, in a distant end of the stairway, may be in a HIGH, raised level of height above the flooring as shown in FIG. 12A. A user is sitting in a wheelchair on a LOW, flooring level of height. The user inputs on the user input means a signal signaling that the user wishes to be lifted from the LOW level to the HIGH level. If no objects are detected by the detection means at the underside of the steps 102,103 of the first type and the second type, the platform will be lowered until the steps form a flat surface at the LOW level surface of the flooring. This level is shown in FIG. 12C. The wheelchair user may enter the steps now forming a platform. When the user is positioned on the steps, when the steps are in the LOW level position, the user may activate the lifting means and be lifted to the HIGH level. The HIGH level is shown in FIG. 12D. When a user wishes to be lowered from the HIGH level to the LOW level, a similar example as the above described may be given. The steps are positioned so as to form a platform on the HIGH level, the user enters the platform at the HIGH level. The user at the platform is then lowered to the LOW level.

The steps may be installed with a second detecting means (not shown) for detection of any objects present on the steps. This is especially needed when the steps form a platform and a user input is given that requests the platform to transform into a stairway. This must not be possible when an object such as a wheelchair with a walking-impaired person or a non-impaired person is present on the platform. The lifting means may in one end of the system be provided with wheels or the like. Wheels or the alike sliding means will enable the movement of the lifting means along the flooring upon alteration of the mutual distance between the actuators at the proximate end of the sidepieces 118 and the actuators in the distant end of the sidepieces, during raising or lowering of the stairway.

In an embodiment according to FIG. 12A, the embodiment may be equipped with a ramp as described with reference to FIG. 11. Thus, when the sidepieces 118 lower and a proximate end 118A of the sidepieces 118 displaces laterally, the sidepieces 118 will force a bar 116 (see FIG. 11) downwards and hereby a ramp may be lifted to form a surface extending from the surface of the flooring to an upper level of the second type of step 3 at the proximate end of the stairway. This feature of the invention is further described in FIG. 14 and FIG. 15.

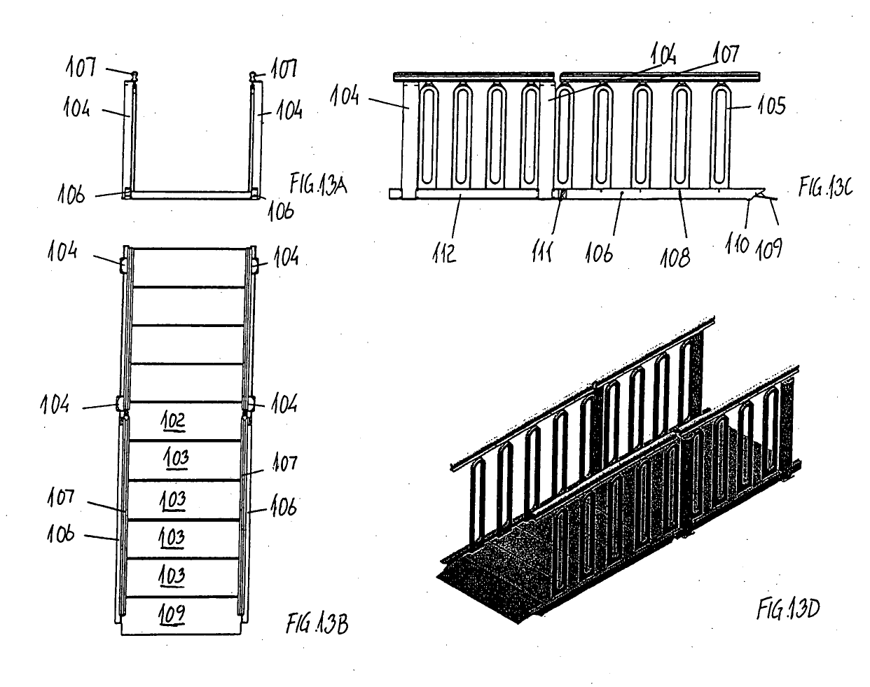

FIG. 13A-13D show the lifting system as shown in FIG. 11 when the steps of the stairway is forming a flat surface and the ramp forms a surface connecting the surface of the steps and the surface of the flooring.

FIG. 14A-14B show the proximate end of the sidepiece 106 having a wheel 110 or the like attached. In particular is shown the ramp 109 attached to the sidepiece 106 at a joint 119. The ramp 109 is provided with an element 121 capable of pivoting around a hinge 120. The element 121 also includes the bar 116 already shown and described on FIG. 11. In FIG. 14, the step 103 of the second type is in a position different from its lowermost position. When the step 103 of the second type and the sidepiece 106 lower towards the flooring, the sidepiece 106 activates the bar 116, and the element 121 will pivot clockwise around the hinge 120. When the sidepiece 106 continues to lower, the pivoting will continue until the one edge of the ramp being closest to the step 104 of the second type is in a vertical level flush with the step 103 of the second type. A supporting beam 123 extending transversely and being connected to the bar 116 is provided so that when the ramp 109 is in its lifted position, the supporting beam 123 is also in a lifted position and is supporting the ramp 109 along the entire transverse extension. Thereby, the load on the joints 119 and the hinges 120 is reduced, and even heavy loads may pass the ramp 109 without the risk of the joints 119 and the hinges 120 being over-loaded and perhaps being damaged. The sidepieces 118 of the embodiments of the invention as shown in FIG. 12A-FIG. 12D may also be provided with a ramp 109 as described.

FIG. 15A-15B show the one end of the sidepiece 106 as shown in FIG. 14, but in FIG. 15 the step 103 is in a lowermost position in relation to the flooring (not shown). The one edge of the ramp being closest to the step 104 of the second type is in a vertical level flush with the step 103. The surface 123 of the element 121 is provided for supporting the ramp 109 along at least a part of the ramp when the step 103 is in a lowermost position to the flooring (not shown).

### LIST OF REFERENCE NUMBERS

| | |
|---|---|
| 1. Lifting system | 101. Lifting system |
| 2. Steps | 102. First type of steps |
| 3a. Banisters | 103. Second type of steps |
| 3b. Lifting control | 104. Lifting means |
| 4a. Vertical guide rail | 105. Baluster |
| 4b. Horizontal guide rail | 106. Sidepiece (side member) |
| 5a. Banister wire or rod | 107. Banister |
| 5b. Vertical banister wire or rod | 108. Swivel joint (first) |
| 6. Wheelchair user | 109. Ramp |
| 7. Activation header | 110. Wheel |
| 8. Door: Locked/unlocked | 111. Hinge/swivel joint (third) |
| or bar: Up/down | |
| 9. Sliding guide such as a wheel | 112. Platform |
| 10. Drive means | 113. First attachment means |
| 11. Lifting means | 114. Second attachment means |
| 12a. Frame | 115. Swivel joint (second) |
| 12b-12c. Detector means | 116. Bar |
| 13. Wheel for sliding wagon | 117. Beam |
| 14. Sliding wagon | 118. Sidepiece 6 hinged to lifting |
| | means in both ends |
| 15-19. Buttons on | 119. Joint |
| activation header | |
| A. First section including | 120. Hinge |
| lifting means | |
| B. Second section | 121. Element |
| C. Flexible connection | 122. Baluster bracket |
| D. Wall or a similar vertical surface | 123. Supporting surface/beam |
| E. Side members | |
| F. Flexible connection | |

1. Lifting system for a stairway comprising
a first section (A) including lifting means (10, 11), a second section (B) including a number of steps (2), step controlling means (3, 5a, 5b), and sliding means (4b, 9), and at least one flexible connection (C) connecting said first (A) and second sections (B), wherein
said second section (B) further includes step controlling means (3, 5a, 5b) comprising one or more banisters (3) and connection means (5a, 5b) connecting said banisters to said steps (2).

2. Lifting system according to claim 1, wherein said lifting means (10, 11) further comprises a number of substantially vertical guide rails (4a), and preferably two.

3. Lifting system according to claim 1, wherein said substantially vertical guide rails (4a) are mounted on a wall (D) or a similar vertical surface.

4. Lifting system according to claim 1, wherein said lifting means (10, 11) comprises drive means (10) such as electric or hydraulic motors.

5. Lifting system according to claim 1, wherein said step connection means (5a, 5b) is connected to said steps (2) in close proximity to the front and rear edges of said steps (2), respectively.

6. Lifting system according to claim 1, wherein said sliding means (4b, 9) comprises a number of substantially horizontal guide rails (4b), and preferably two.

7. Lifting system according to claim 1, wherein said sliding means (4b, 9) comprises sliding guides (9) for entering into said horizontal guide rails (4b).

8. Lifting system according to claim 1, wherein said first section (A) further includes a door (8), a bar or another access controlling means.

9. Lifting system according to claim 1, wherein the number of steps is between 1 and 15.

10. Method of lifting cargo/person(s) by means of a lifting system from one level to another, said method comprising the steps of
lifting a first section (A) by means of lifting means (10, 11),
lifting a second section (B) including a number of steps (s),
said lifting of said second section (B) being performed through a flexible connection (C) to said first section (A),
whereby the position of said number of steps is controlled by step controlling means (3, 5a, 5b) comprising one or more banisters (3) and connection means (5a, 5b) connecting said banisters to said steps (2).

11. Method according to claim 10, said method further comprising the step of
said at least one sliding guide (9) of said second section (B) sliding in a horizontal guide rail during said lifting

12. Method according to claim 10, said lifting system further comprising
two first sections, the one of said first sections being provided in the vicinity of each of the two ends of said banisters and wherein each of said two first sections (A), is a step of a first type of steps (102) and said second section (B) comprises a number of a second type of steps (103) and said method comprising the steps of
activating one of said lifting means provided in connection with each of said two steps and hereby providing
a raising or a lowering of one of said two first type of step (102) and hereby raising or lowering of said at least one second type of step.

13. Method according to claim 12, said method further comprising the steps of
activating at least one of said lifting means provided in connection with each of said two steps of said first type and hereby providing
raising or lowering of at least one of said two first type of step (102) and hereby raising or lowering of said at least one second type of step (103) and hereby
providing a substantially equal level of relative height above a predetermined flooring level of said two first type of steps (102), and hereby
obtaining a platform comprising of said steps of said first type of steps (102) and said steps of said second type of steps (103).

14. Method according to claim 12, said method further comprising the steps of
activating a substantially equal lowering or raising of said lifting means provided in connection with each of said two steps of said first type while
maintaining said platform and hereby providing a lifting platform comprised by said steps of said two types for raising or lowering of objects and/or persons.

15. A lifting system for a stairway comprising a first section (A) including lifting means (10, 11), a second section (B) including a number of steps (2), step controlling means (3, 5a, 5b), and sliding means (4b, 9), and at least one flexible connection (C) connecting said first (A) and second sections (B), wherein said second section (B) further includes step controlling means (3, 5a, 5b) comprising one or more banisters (3) and connection means (5a, 5b) connecting said banisters to said step (2) and
said first section (A) comprises at least one step of a first type (102), and
said second section (B) comprises at least one step of a second type (103), and
said step controlling means comprises at least one banister (107), and
said flexible connection comprises a third swivel joint (111), and
said connection means comprises at least one baluster (105).

16. A lifting system for a stairway according to claim 15, said lifting system comprising
at least one step of said first type (102) and at least one step of said second type (102), said first type of steps and second type of step(s) (103) being provided displaceable in relation to each other,
said at least one step of the first type being fixed to at least one lifting means (104) for raising and lowering the at least one first type of step (102) and the at least one second type of step (103),
at least one step of said first (102) or second type of step (103) being fixed to a lower end of at least one substantially vertically extending baluster (105), and
an upper section of said at least one baluster (105) being attached to said banister (107), said banister extending from a proximate end of the stairway to a distant end of the stairway,
at least one step of said first (102) or second type of step (103) together with said at least one baluster (105) being able to pivot at first swivel joints (108) of the two sidepieces (106) of the stairway in the proximity of the lower end of said baluster, said at least two sidepieces (106) extending from the proximate end of the stairway to the distant end of the stairway, and
said at least one baluster (105) being pivotally joined to the banister (107) at second swivel joints (115) in the proximity of the upper end of said at least one baluster (105), and
each of said two sidepieces (106) being pivotally hinged to said lifting means at third swivel joints (111) in the proximity of distant ends of said two sidepieces, and
wherein activating said lifting means (104) provides a raising or a lowering of said at least one first type of step (102) and hereby a raising or lowering of said at least one second type of step (103),
said at least one step of the first type or the second type being fixed to a lower end of at least one substantially vertically extending baluster (105), and
an upper section of the at least one baluster (105) being attached to the banister (107), the banister extending from a proximate end of the stairway to a distant end of the stairway,
the at least one step of the first type or the second type together with the at least one baluster (105) being able to (106) of the stairway in the proximity of the lower end of.

17. A lifting system according to claim 15, wherein one of the first type of steps (102) is attached to a platform or is forming a platform, said platform being intended for being raised or lowered by the lifting means (104) by the attachment of the first type of step to the lifting means, and said lifting means being adapted for providing a force on said first type of step (102), which is substantially in the direction of gravity, and said sidepieces (106) in a proximate end being provided with sliding means for allowing a lateral displacement of the sidepieces.

18. A lifting system according to claim 15, wherein one of the first type of step is provided in each end of the sidepieces (118) and the lifting means (104) is hinged to the sidepieces with hinges in both ends (118), and at least one of the second type of steps (103) is further provided along the sidepieces (118) so as to provide a platform formed by the steps, when said lifting means (104) in both ends of the sidepieces is raised or lowered to a level being equal in both of said ends.

19. A lifting system according to claim 15, wherein a first step of the second type of step (103) is provided with a ramp (109) for enabling a walking-impaired person and/or an aid for a walking-impaired person to enter or exit the first step, when said first step is in a lowermost position.

20. A lifting system according to claim 15, wherein the steps (103) are rigidly attached to the lower end of the balusters (105) by a first attachment means, said first attachment means also being provided with means for attaching said first attachment means to the first swivel joints (108) of the sidepieces (106), said first attachment means thus interconnecting the steps (103) with the sidepieces by means of the first swivel joints (108).

21. A lifting system according to claim 15, wherein an upper end of the baluster (105) is being pivotally attached to the banister (107) by rigidly attaching the upper end of the baluster to a second attachment means, said second attachment means also being provided with means for forming the second swivel joint (115) with the banister, said second attachment means thus interconnecting the baluster with the banister by means of the second swivel joints (15).

22. A lifting system according to claim 15, wherein at least one of the first type of steps or second type of steps comprises a first detection means at an underside of the step for detection of any objects obstructing the steps from being lowered.

23. A lifting system according to claim 15, wherein at least one of the first type of steps or second type of steps comprises a second detection means for detection of any objects present on the step(s).

24. A lifting system according to claim 15, said lifting system further comprising a control means being provided for receiving an input by a user and being connected to the lifting means and to the first detection means, said control means being capable of activating the lifting means according to user input and at the same time controlling the lifting means to be lowered only when clear signals are received from the first detection means.

25. A lifting system according to claim 15, said lifting system further comprising a control means being provided for receiving an input by a user and being connected to the lifting means and to the first and second detection means, said control means being capable of activating the lifting means according to user input and at the same time controlling the lifting means to be lowered only when clear signals are received from the first and second detection means.
